(19) United States
(12) Patent Application Publication
(10) Pub. No.: US 2022/0392239 A1
(43) Pub. Date: Dec. 8, 2022

(54) METHOD FOR LABELING IMAGE, ELECTRONIC DEVICE, AND STORAGE MEDIUM

(71) Applicant: SHANGHAI SENSETIME INTELLIGENT TECHNOLOGY CO., LTD., Shanghai (CN)

(72) Inventor: Weijia Li, Shanghai (CN)

(21) Appl. No.: 17/886,565

(22) Filed: Aug. 12, 2022

Related U.S. Application Data
(63) Continuation of application No. PCT/CN2021/084175, filed on Mar. 30, 2021.

(30) Foreign Application Priority Data
Jun. 29, 2020 (CN) 202010611570.X

(51) Int. Cl. G06V 20/70; G06T 7/13; G06T 7/11; G06V 10/22; G06V 10/82; G06T 7/73; G06V 10/24; G06V 20/10

(52) U.S. Cl. CPC G06V 20/70; G06T 7/13; G06T 7/11; G06V 10/225; G06V 10/82; G06T 7/73; G06V 10/24; G06V 20/176; G06T 2207/20084; G06T 2207/20081; G06T 2207/10032; G06T 2207/30184

(57) ABSTRACT

A method for labeling an image, an electronic device, and a storage medium are provided. The method includes the following operations. A remote sensing image is acquired. A local binary image respectively corresponding to at least one building in the remote sensing image and direction angle information of a contour pixel located on a building contour in the local binary image are determined based on the remote sensing image. The direction angle information includes information of an angle between a contour edge where the contour pixel is located and a preset reference direction. A labeled image labeled with a polygonal contour of the at least one building in the remote sensing image is generated based on the local binary image respectively corresponding to the at least one building and the direction angle information.

### CROSS-REFERENCE TO RELATED APPLICATION

The present application is a continuation of International Patent Application No. PCT/CN2021/084175, filed on Mar. 30, 2021, which is based upon and claims priority to Chinese Patent Application No. 202010611570.X, filed on Jun. 29, 2020. The disclosures of International Patent Application No. PCT/CN2021/084175 and Chinese Patent Application No. 202010611570.X are hereby incorporated by reference in their entireties.

### BACKGROUND

Building contour extraction may provide important basic information for urban planning, environmental management, geographic information updating, etc. At present, the accuracy of a fully-automatic building contour extraction method is low due to the diversity and complexity of building shapes, it is difficult to meet the needs of practical applications, and the fully-automatic building contour extraction method cannot replace a traditional manual labeling method. However, manual labeling of building polygons is a time-consuming and laborious task, and is usually performed by professional remote sensing image interpreters, so that the manual labeling method is inefficient.

Therefore, it is very important to propose a method that balances accuracy and labeling efficiency.

### SUMMARY

The disclosure relates to the technical field of computer vision, and particularly, to a method for labeling an image, an electronic device, and a storage medium.

In view of this, the disclosure at least provides a method and apparatus for labeling an image, an electronic device, and a storage medium.

In a first aspect, an embodiment of the disclosure provides a method for labeling an image, which may include the following operations. A remote sensing image is acquired. A local binary image respectively corresponding to at least one building in the remote sensing image and direction angle information of a contour pixel located on a building contour in the local binary image are determined based on the remote sensing image. The direction angle information includes information of an angle between a contour edge where the contour pixel is located and a preset reference direction. A labeled image labeled with a polygonal contour of the at least one building in the remote sensing image is generated based on the local binary image respectively corresponding to the at least one building and the direction angle information.

In a second aspect, an embodiment of the disclosure provides an electronic device, which may include a processor, a memory, and a bus. The memory may store machine-readable instructions executable by the processor. When the electronic device operates, the processor may communicate with the memory through the bus. The machine-readable instruction may be executed by the processor to perform steps of: acquiring a remote sensing image; determining a local binary image respectively corresponding to at least one building in the remote sensing image and direction angle information of a contour pixel located on a building contour in the local binary image based on the remote sensing image, the direction angle information comprising information of an angle between a contour edge where the contour pixel is located and a preset reference direction; and generating a labeled image labeled with a polygonal contour of the at least one building in the remote sensing image based on the local binary image respectively corresponding to the at least one building and the direction angle information.

In a fourth aspect, an embodiment of the disclosure provides a computer-readable storage medium, which may have a computer program stored thereon which, when executed by a processor, may perform steps of: acquiring a remote sensing image; determining a local binary image respectively corresponding to at least one building in the remote sensing image and direction angle information of a contour pixel located on a building contour in the local binary image based on the remote sensing image, the direction angle information comprising information of an angle between a contour edge where the contour pixel is located and a preset reference direction; and generating a labeled image labeled with a polygonal contour of the at least one building in the remote sensing image based on the local binary image respectively corresponding to the at least one building and the direction angle information.

In order that the above objects, features and advantages of the disclosure are more comprehensible, preferred embodiments accompanied with the accompanying drawings are described in detail below.

### BRIEF DESCRIPTION OF THE DRAWINGS

For describing the technical solutions of the embodiments of the disclosure more clearly, the drawings required to be used in the embodiments will be simply introduced below. The drawings, which are incorporated in and constitute a part of this specification, illustrate embodiments consistent with the disclosure and, together with the specification, serve to explain the technical solutions of the embodiments of the disclosure. It is to be understood that the following drawings only illustrate some embodiments of the disclosure and thus should not be considered as limits to the scope. Those of ordinary skill in the art may also obtain other related drawings according to these drawings without creative work.

FIG. 1 is a schematic flowchart of a method for labeling an image according to an embodiment of the disclosure.

FIG. 2 is a schematic flowchart of a method for determining direction angle information according to an embodiment of the disclosure.

FIG. 3 is a schematic flowchart of a method for training a first image segmentation neural network according to an embodiment of the disclosure.

FIG. 4 is a schematic diagram of a building polygonal contour according to an embodiment of the disclosure.

FIG. 5 is a schematic flowchart of a method for training a second image segmentation neural network according to an embodiment of the disclosure.

FIG. 6 is a schematic flowchart of a method for generating a labeled image according to an embodiment of the disclosure.

FIG. 7 is a schematic flowchart of a method for determining a vertex position set according to an embodiment of the disclosure.

FIG. 8 is a schematic architecture diagram of an apparatus for labeling an image according to an embodiment of the disclosure.

FIG. 9 is a schematic structural diagram of an electronic device according to an embodiment of the disclosure.

### DETAILED DESCRIPTION

In order to make the objectives, technical solutions, and advantages of the embodiments of the disclosure clearer, the technical solutions in the embodiments of the disclosure will be clearly and completely described below in combination with the drawings in the embodiments of the disclosure. It is apparent that the described embodiments are not all but only part of embodiments of the disclosure. Components, described and shown in the drawings, of the embodiments of the disclosure may usually be arranged and designed with various configurations. Therefore, the following detailed descriptions about the embodiments of the disclosure provided in the drawings are not intended to limit the claimed scope of the disclosure but only represent selected embodiments of the disclosure. All other embodiments obtained by those skilled in the art based on the embodiments of the disclosure without creative work shall fall within the scope of protection of the disclosure.

Generally, since a fully automatic building extraction method has low accuracy and is difficult to meet the practical application requirements, the fully automatic building extraction method cannot replace a traditional manual labeling method and cannot be widely used. However, the traditional manual labeling method for building polygons is a time-consuming and laborious task, and is usually performed by professional remote sensing image interpreters, so that the manual labeling method is inefficient.

In order to solve the above problems, an embodiment of the disclosure provides a method for labeling an image that improves the efficiency of building labeling while ensuring the accuracy of building labeling.

In order to facilitate an understanding of the embodiment of the disclosure, a method for labeling an image according to the embodiment of the disclosure will first be described in detail.

The method for labeling an image provided by the embodiment of the disclosure may be applied to a terminal device and may also be applied to a server. The terminal device may be a computer, a smart phone, a tablet computer, etc., and the embodiment of the disclosure is not limited thereto.

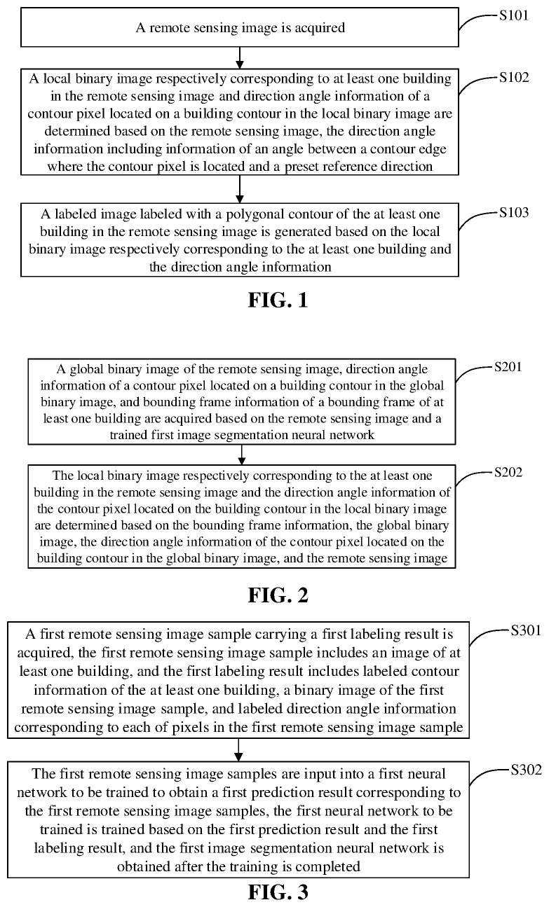

FIG. 1 shows a schematic flowchart of a method for labeling an image according to an embodiment of the disclosure. The method includes S101-S103.

At S101, a remote sensing image is acquired.

At S102, a local binary image respectively corresponding to at least one building in the remote sensing image and direction angle information of a contour pixel located on a building contour in the local binary image are determined based on the remote sensing image. The direction angle information includes information of an angle between a contour edge where the contour pixel is located and a preset reference direction.

At S103, a labeled image labeled with a polygonal contour of the at least one building in the remote sensing image is generated based on the local binary image respectively corresponding to the at least one building and the direction angle information.

In the above method, a local binary image respectively corresponding to at least one building in a remote sensing image and direction angle information of a contour pixel located on a building contour in the local binary image are determined based on the remote sensing image. The direction angle information includes information of an angle between a contour edge where the contour pixel is located and a preset reference direction. A labeled image labeled with a polygonal contour of the at least one building in the remote sensing image is generated based on the local binary image respectively corresponding to the at least one building and the direction angle information. The automatic generation of the labeled image labeled with the polygonal contour of the at least one building in the remote sensing image is realized, and the efficiency of building labeling is improved.

Meanwhile, since a pixel located at a vertex position on an edge contour of a building and an adjacent pixel are located on different contour edges and different contour edges correspond to different directions, the vertex position of the building may be determined more accurately through a local binary image corresponding to the building and direction angle information, and then a labeled image may be generated more accurately.

For S101 and S102, here, the remote sensing image may be an image in which at least one building is recorded. After a remote sensing image is acquired, a local binary image corresponding to each building included in the remote sensing image and direction angle information of a contour pixel located on a building contour in the local binary image are determined. For example, in the local binary image corresponding to each building, a pixel value of the pixel in a corresponding region of the building may be 1, and a pixel value of a pixel in a background region other than the corresponding region of the building in the local binary image may be 0. The direction angle information includes angle information between a contour edge where a contour pixel is located and a preset reference direction.

As an optional implementation, FIG. 2 shows a schematic flowchart of a method for determining direction angle information according to an embodiment of the disclosure. The operation that the local binary image respectively corresponding to the at least one building in the remote sensing image and the direction angle information of the contour pixel located on the building contour in the local binary image are determined based on the remote sensing image may include the following operations.

At S201, a global binary image of the remote sensing image, direction angle information of a contour pixel located on a building contour in the global binary image, and bounding frame information of a bounding frame of at least one building are acquired based on the remote sensing image and a trained first image segmentation neural network.

At S202, the local binary image respectively corresponding to the at least one building in the remote sensing image and the direction angle information of the contour pixel located on the building contour in the local binary image are determined based on the bounding frame information, the global binary image, the direction angle information of the contour pixel located on the building contour in the global binary image, and the remote sensing image.

In the above implementation, a global binary image of the remote sensing image, direction angle information of a contour pixel located on a building contour in the global binary image, and bounding frame information of a bounding frame of at least one building are determined through a trained first image segmentation neural network. Then a local binary image corresponding to each building and direction angle information of a contour pixel located on a building contour in the local binary image may be obtained, and data support is provided for subsequent generation of a labeled image.

In S201, the remote sensing image may be input into a trained first image segmentation neural network to obtain a global binary image of the remote sensing image, direction angle information of a contour pixel located on a building contour in the global binary image, and bounding frame information of a bounding frame of at least one building.

Exemplarily, the global binary image is of the same size as the remote sensing image, and the global binary image may be a binary image in which a pixel value of a pixel in a building region is 255 and a pixel value of a pixel in a background region other than the building region is 0. The direction angle information of a contour pixel on a building contour may be an angle between a contour edge where the contour pixel is located and a set direction. For example, direction angle information of a contour pixel A may be 180°, and direction angle information of a contour pixel B may be 250°; or the direction angle information of a contour pixel on a building contour may also be a direction type corresponding to the contour pixel. For example, direction angle information of a contour pixel A may be a 19th direction type, and direction angle information of a contour pixel B may be a 26th direction type. The direction type may be determined by an angle between a contour edge where the contour pixel is located and a set direction.

Exemplarily, a bounding frame of each building, which may be a square frame surrounding a contour region of the building, may also be determined according to contour information of each building included in the global binary image. During implementation, a first size maximum of the building in a length direction and a second size maximum in a width direction may be determined, and a larger value of the first size maximum and the second size maximum is determined as a size value of the bounding frame of the building. The bounding frame information of the bounding frame may include size information of the bounding frame, position information of the bounding frame, etc.

FIG. 3 shows a schematic flowchart of a method for training a first image segmentation neural network according to an embodiment of the disclosure. A first image segmentation neural network may be trained by the following steps to obtain a trained first image segmentation neural network.

At S301, a first remote sensing image sample carrying a first labeling result is acquired. The first remote sensing image sample includes an image of at least one building. The first labeling result includes labeled contour information of the at least one building, a binary image of the first remote sensing image sample, and labeled direction angle information corresponding to each of pixels in the first remote sensing image sample.

At S302, the first remote sensing image sample is input into a first neural network to be trained to obtain a first prediction result corresponding to the first remote sensing image sample, the first neural network to be trained is trained based on the first prediction result and the first labeling result, and the first image segmentation neural network is obtained after the training is completed.

For S301, the acquired first remote sensing image includes images of one or more buildings. The first labeling result includes contour information of each building in the first remote sensing image sample, a binary image of the first remote sensing image sample, and labeled direction angle information corresponding to each of pixels in the first remote sensing image sample.

The labeled direction angle information of the pixel located on the edge contour of the building in the first remote sensing image sample may be determined according to an angle between an edge of the edge contour of the building where the pixel is located and a preset direction. The labeled direction angle information of other pixels located outside the edge contour of the building may be set as a preset value. For example, the labeled direction angle information of other pixels located outside the edge contour of the building may be set as 0.

When the labeled direction angle information corresponding to each labeled pixel is angle information, a target angle between an edge of the edge contour of the building where the pixel is located and a preset reference direction may be determined as the labeled direction angle information of the pixel.

When the labeled direction angle information corresponding to each labeled pixel is direction type information, the direction type information corresponding to each pixel is acquired according to the following steps. A target angle between a contour edge where the pixel is located and a set reference direction is determined. Labeling direction type information corresponding to the pixel is determined according to correspondences between different preset direction type information and angle ranges, and the target angle.

Here, direction type information corresponding to a pixel is determined through a target angle of the pixel and a set corresponding relationship between different preset direction types and angle ranges. The process of determining the direction type information of the pixel is simple and rapid.

Here, the set corresponding relationship between different preset direction type information and angle ranges may be as follows. The angle range is [0°, 10°), and the corresponding preset direction type information is a first direction type. The range includes 0° but does not include 10°. The angle range is [10°, 20°), and the corresponding preset direction type information is a second direction type. The angle range is [350°, 360°), and the corresponding preset direction type information is a 36th direction type. Further, after a target angle between a contour edge where a pixel is located and a set reference direction is determined, labeling direction type information corresponding to the pixel may be determined according to the target angle and a corresponding relationship between different preset direction type information and angle ranges. For example, when a target angle corresponding to a pixel is 15°, labeling direction type information corresponding to the pixel is the second direction type.

During implementation, the labeling direction type information corresponding to the pixel may also be calculated by using the target angle according to the following formula (1):

yₒ(i)=[αᵢ×K/360°+1] Formula (1)

αᵢ is a target angle corresponding to a pixel i, K is the number of direction types, yₒ(i) is a direction type identifier corresponding to the pixel i, and symbol [ ] may be a rounding operation symbol. For example, when the target angle between a contour edge where the pixel i is located and the set reference direction is 180° and the number of set direction types is 36, i.e., K is 36, yₒ(i)=19, i.e., the labeling direction type information corresponding to the pixel i is the 19^{th} direction type. When the target angle between the contour edge where the pixel i is located and the set reference direction is 220° and the number of set direction types is 36, i.e., K is 36, yₒ(i)=23, i.e., the labeling direction type information corresponding to the pixel i is the 23^{rd} direction type.

FIG. 4 shows a schematic diagram of a building polygonal contour. The figure includes a polygonal contour 21 of the building and an angle example 22. A direction of 0° in the angle example may be a set reference direction. The polygonal contour 21 includes: a first contour edge 211, and a direction (1) of the first contour edge; a second contour edge 212, and a direction (2) of the second contour edge; a third contour edge 213, and a direction (3) of the third contour edge; a fourth contour edge 214, and a direction (4) of the fourth contour edge; a fifth contour edge 215, and a direction (5) of the fifth contour edge; a sixth contour edge 216, and a direction (6) of the sixth contour edge; a seventh contour edge 217, and a direction (7) of the seventh contour edge; and an eighth contour edge 218, and a direction (8) of the eighth contour edge. A direction perpendicular to each contour edge and towards the outside of the building may be determined as the direction of the contour edge.

Further, an angle between each contour edge in the polygonal contour 21 of the building and the reference direction is known in connection with the angle example 22. That is, the angle between the first contour edge and the reference direction is 0°, the angle between the second contour edge and the reference direction is 90°, the angle between the third contour edge and the reference direction is 180°, the angle between the fourth contour edge and the reference direction is 90°, the angle between the fifth contour edge and the reference direction is 0°, the angle between the sixth contour edge and the reference direction is 90°, the angle between the seventh contour edge and the reference direction is 180°, and the angle between the eighth contour edge and the reference direction is 270°.

For S302, the acquired first remote sensing image sample carrying the first labeling result may be input into a first neural network to be trained to obtain a first prediction result corresponding to the first remote sensing image sample. The first prediction result includes prediction contour information of each building included in the first remote sensing image sample, a prediction binary image of the first remote sensing image sample, and prediction direction angle information corresponding to each of pixels in the first remote sensing image sample.

Further, a loss value of the first neural network may be determined based on the first prediction result and the first labeling result, the first neural network may be trained by using the determined loss value, and the first image segmentation neural network may be obtained after the training is completed. For example, a first loss value L_{bound} may be determined by using the prediction contour information of each building in the first prediction result and the contour information of the corresponding building labeled in the first labeling result. A second loss value L_{seg} may be determined by using the prediction binary image of the first remote sensing image sample in the first prediction result and the binary image of the first remote sensing image sample in the first labeling result. A third loss value Lₒᵣᵢₑₙₜ may be determined by using the prediction direction angle information corresponding to each of pixels in the first remote sensing image sample in the first prediction result and the labeled direction angle information corresponding to each of pixels in the first remote sensing image sample in the first labeling result. A sum Lₜₒₜₐₗ of the first loss value L_{bound}, the second loss value L_{seg} and the third loss value Lₒᵣᵢₑₙₜ (i.e., Lₜₒₜₐₗ=L_{bound}+L_{seg}+Lₒᵣᵢₑₙₜ) is taken as a loss value of the first neural network to train the first neural network. Exemplarily, the first loss value, the second loss value, and the third loss value may be calculated by a cross-entropy loss function.

In the above implementation, a first neural network is trained by acquiring a first remote sensing image sample, and a first image segmentation neural network is obtained after the training is completed, so that a local binary image of a building in a first bounding frame and direction angle information are determined through the first image segmentation neural network.

In S202, as an optional implementation, the local binary image respectively corresponding to the at least one building in the remote sensing image and the direction angle information of the contour pixel located on the building contour in the local binary image are determined according to the following implementations.

In the first implementation, a first bounding frame having a size greater than a preset size threshold is selected from the at least one bounding frame based on the bounding frame information, a local binary image of a building within the first bounding frame is clipped from the global binary image based on the bounding frame information of the first bounding frame, and direction angle information of a contour pixel located on the building contour in the clipped local binary image is extracted from the direction angle information corresponding to the global binary image.

In the second implementation, a second bounding frame having a size less than or equal to the preset size threshold is selected from the at least one bounding frame based on the bounding frame information, a local remote sensing image corresponding to the second bounding frame is clipped from the remote sensing image based on bounding frame information of the second bounding frame, and a local binary image of the building corresponding to the local remote sensing image, and direction angle information of a contour pixel located on the building contour in a local binary image corresponding to the local remote sensing image are determined based on the local remote sensing image and a trained second image segmentation neural network.

Here, according to the size of the bounding frame of the building, it may be determined whether to use the first implementation or the second implementation to determine a local binary image corresponding to each building and direction angle information of a contour pixel located on a building contour in the local binary image. When the size of a bounding frame of a building is greater than the preset size threshold, the first implementation is selected to determine a local binary image corresponding to the building and direction angle information of a contour pixel located on a building contour in the local binary image. When the size of a bounding frame of a building is less than or equal to the preset size threshold, the second implementation is selected to intercept a local remote sensing image corresponding to the second bounding frame from the remote sensing image, and determine a local binary image of the building corresponding to the local remote sensing image, and direction angle information of a contour pixel located on the building contour in a local binary image corresponding to the local remote sensing image based on the local remote sensing image and a trained second image segmentation neural network.

Generally, the size of input data of a neural network is preset. In the case where the size of a bounding frame of a building is large, the size of the bounding frame needs to be adjusted to the preset size value by reducing, cutting, etc. which will result in the loss of information in the bounding frame, thereby reducing the detection accuracy of the building in the bounding frame. Therefore, in order to solve the above problem, in the above implementation, the bounding frame of the building is divided into a first bounding frame having a size greater than a preset size threshold and a second bounding frame having a size less than the preset size threshold based on the size of the bounding frame. A local binary image corresponding to the building within the first bounding frame and direction angle information are determined by a detection result of the first image segmentation neural network. A local binary image corresponding to the building in the second bounding frame and direction angle information are determined by a detection result of the second image segmentation neural network, so that the building detection results are more accurate.

The first implementation is described. A first bounding frame having a size greater than a preset size threshold may be selected from at least one bounding frame based on the size of the bounding frame indicated by the bounding frame information. A local binary image of a building within the first bounding frame is clipped from the global binary image based on the position of the bounding frame indicated in the bounding frame information of the first bounding frame. The size of the binary image may be the same as that of the first bounding frame. Direction angle information corresponding to the first bounding frame is extracted from the direction angle information corresponding to the global binary image, that is, direction angle information of a contour pixel located on a building contour in the local binary image is obtained.

The second implementation is described. A second bounding frame having a size less than or equal to the preset size threshold may be selected from at least one bounding frame based on the size of the bounding frame indicated in the bounding frame information. The second bounding frame is a bounding frame other than the first bounding frame in at least one bounding frame of the detected remote sensing image. Further, a local remote sensing image corresponding to the second bounding frame is clipped from the remote sensing image based on the position of the bounding frame indicated in the bounding frame information of the second bounding frame, and the obtained local remote sensing image is input into a trained second image segmentation neural network to determine a local binary image of the building corresponding to the local remote sensing image, and direction angle information of a contour pixel located on the building contour in a local binary image corresponding to the local remote sensing image.

In an optional implementation, FIG. 5 shows a schematic flowchart of a method for training a second image segmentation neural network according to an embodiment of the disclosure. A second image segmentation neural network may be trained by the following steps.

At S401, second remote sensing image samples carrying a second labeling result are acquired. Each of the second remote sensing image samples is a region image of a target building clipped from the first remote sensing image sample. The second labeling result includes contour information of the target building in the region image, a binary image of the second remote sensing image sample, and labeled direction angle information corresponding to each of pixels in the second remote sensing image sample.

At S402, the second remote sensing image sample is input into a second neural network to be trained to obtain a second prediction result corresponding to the second remote sensing image sample, the second neural network to be trained is trained based on the second prediction result and the second labeling result, and the second image segmentation neural network is obtained after the training is completed.

Here, the second remote sensing image sample may be a region image of a target building clipped from the first remote sensing image sample, i.e., the second remote sensing image sample includes a target building, and the corresponding size of the second remote sensing image sample is less than that of the first remote sensing image sample. The second labeling result carried by the second remote sensing image sample may be obtained from the second labeling result of the first remote sensing image sample. For example, contour information of a target building in the second remote sensing image sample may be clipped from the contour information of each building included in the first remote sensing image sample.

The acquired second remote sensing image sample carrying the second labeling result may be input into a second neural network to be trained to obtain a second prediction result corresponding to the second remote sensing image sample. The second prediction result includes prediction contour information of each building included in the second remote sensing image sample, a prediction binary image of the second remote sensing image sample, and prediction direction angle information corresponding to each of pixels in the second remote sensing image sample. Further, a loss value of the second neural network may be determined based on the second prediction result and the second labeling result corresponding to the second remote sensing image sample, the second neural network may be trained by using the determined loss value of the second neural network, and the second image segmentation neural network may be obtained after the training is completed. The training process of the second neural network may be referred to the training process of the first neural network and will not be elaborated herein.

In the above implementation, a second remote sensing image is clipped from a first remote sensing image sample, a second neural network is trained by using an acquired second remote sensing image sample, and a second image segmentation neural network is obtained after the training is completed, so that a local binary image of a building in a second bounding frame and direction angle information are determined through the second image segmentation neural network.

In an optional implementation, after the bounding frame information of the at least one bounding frame is acquired, the method further includes the following operations. A first labeled remote sensing image labeled with the at least one bounding frame is generated based on the remote sensing image and the bounding frame information of the at least one bounding frame. Bounding frame information of an adjusted bounding frame is obtained in response to a bounding frame adjustment operation performed on the first labeled remote sensing image.

Here, after the bounding frame information of the at least one bounding frame is acquired, a first labeled remote sensing image labeled with the at least one bounding frame may be generated based on the remote sensing image and the determined bounding frame information of the at least one bounding frame, and the first labeled remote sensing image may be displayed on a display screen, so that a labeling operator may view the first labeled remote sensing image on the display screen, and may perform a bounding frame adjustment operation on the first labeled remote sensing image.

For example, the redundant bounding frame in the first labeled remote sensing image may be deleted. That is, when a building is not included in a bounding frame A in the first labeled remote sensing image (the bounding frame A in the first labeled remote sensing image is a redundant bounding frame), the bounding frame A may be deleted from the first labeled remote sensing image. And a missing bounding frame may also be added to the first labeled remote sensing image. That is, when the first labeled remote sensing image includes a building A, but the building A does not detect a corresponding bounding frame (the bounding frame of the building A is missing in the first labeled remote sensing image), a corresponding bounding frame may be added to the building A. Then, bounding frame information of an adjusted bounding frame is obtained in response to a bounding frame adjustment operation performed on the first labeled remote sensing image.

Here, after the bounding frame information of at least one bounding frame is obtained, a first labeled remote sensing image may be generated, so that a labeler can perform an adjustment operation on the bounding frame on the first labeled remote sensing image, e.g. deleting redundant bounding frames and adding missing bounding frames. The accuracy of the bounding frame information is improved, and the accuracy of a subsequently obtained labeled image can be further improved. Moreover, the bounding frame adjustment operation is simple and easy to operate, and takes less time, and the efficiency of the bounding frame adjustment operation is high.

For S103, here, a labeled image labeled with a polygonal contour of the at least one building in the remote sensing image may be generated based on the local binary image respectively corresponding to each building included in the remote sensing image and the direction angle information.

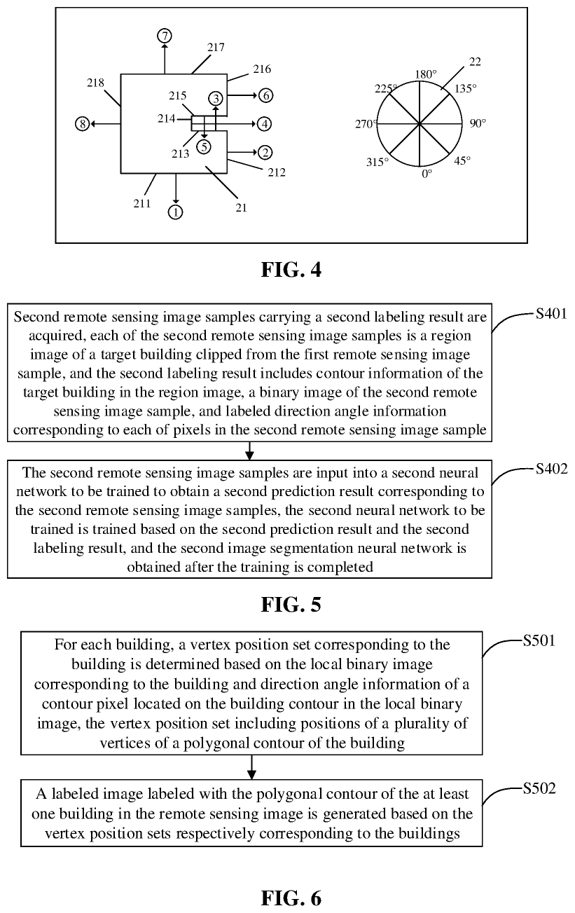

In an optional implementation, FIG. 6 is a schematic flowchart of a method for generating a labeled image according to an embodiment of the disclosure. The operation that the labeled image labeled with the polygonal contour of the at least one building in the remote sensing image is generated based on the local binary image respectively corresponding to the at least one building and the direction angle information may include the following operations.

At S501, for each building, a vertex position set corresponding to the building is determined based on the local binary image corresponding to the building and direction angle information of a contour pixel located on the building contour in the local binary image. The vertex position set includes positions of a plurality of vertices of a polygonal contour of the building.

At S502, a labeled image labeled with the polygonal contour of the at least one building in the remote sensing image is generated based on the vertex position sets respectively corresponding to the buildings.

In the above implementation, since a pixel located at a vertex position of a building and an adjacent pixel are located on different contour edges and different contour edges correspond to different directions, a vertex position set of the building may be determined more accurately through a local binary image corresponding to each building and direction angle information. The vertex position set includes a position of each vertex on the polygonal contour of the building, and then a labeled image may be generated more accurately based on the obtained vertex position set.

For S501, for each building included in the remote sensing image, a vertex position set corresponding to the building may be determined based on the local binary image corresponding to the building and direction angle information of a contour pixel located on the building contour in the local binary image. That is, the vertex position set corresponding to the building includes position information of each vertex on a building polygonal contour corresponding to the building.

As an optional implementation, FIG. 7 shows a schematic flowchart of a method for determining a vertex position set according to an embodiment of the disclosure. In S501, the operation that the vertex position set formed by the plurality of vertex positions of the polygonal contour of the building is determined based on the local binary image corresponding to the building and the direction angle information of the contour pixel located on the building contour in the local binary image may include the following operations.

At S601, a plurality of pixels are selected from the building contour in the local binary image.

At S602, for each of the plurality of pixels, it is determined whether the pixel belongs to a vertex of a polygonal contour of a building based on direction angle information corresponding to the pixel and direction angle information of an adjacent pixel corresponding to the pixel.

At S603, a vertex position set corresponding to the building is determined according to the determined positions of respective pixels belonging to the vertex.

In the above implementation, a plurality of pixels may be selected from a building contour, it may be judged whether each pixel is a vertex, and then a vertex position set corresponding to the building may be generated based on the positions of respective pixels belonging to the vertex, so as to provide data support for the subsequent generation of a labeled image.

S601 is described. A plurality of pixels may be selected from the building contour in the local binary image. For example, a plurality of pixels may be selected from the building contour by taking points densely.

Here, it is also possible to label the selected plurality of pixels in sequence. For example, a starting point may be selected, a label of a pixel at the starting point position is set to 0, and a label of a pixel adjacent to the pixel with the label of 0 is set to 1 according to a clockwise direction. By analogy, a corresponding label is determined for each pixel in the selected plurality of pixels. And pixel coordinates of the plurality of pixels are used to generate a dense pixel coordinate set P={p₀, p₁, . . . , pₙ}. n is a positive integer. p₀ is a pixel coordinate of a pixel with the label of 0, and pn is a pixel coordinate of a pixel with the label of n.

S602 is described. Each pixel of the selected plurality of pixels is judged, and it is judged whether the pixel belongs to the vertex of the polygonal contour of the building.

As an optional implementation, in S602, the operation that it is determined whether the pixel belongs to the vertex of the polygonal contour of the building based on the direction angle information corresponding to the pixel and the direction angle information of the adjacent pixel corresponding to the pixel may include the following operation. It is determined that the pixel belongs to the vertex of the polygonal contour of the building when a difference between the direction angle information of the pixel and the direction angle information of the adjacent pixel satisfies a set condition.

In the above implementation, when a difference between direction angle information of a pixel and direction angle information of an adjacent pixel satisfies a set condition, it is determined that the pixel belongs to a vertex of a polygonal contour of a building. The process of determining the vertex is simple and time-consuming.

When the direction angle information is a target angle, it may be judged whether a difference between the target angle of the pixel and the target angle of an adjacent pixel is greater than or equal to a set angle threshold. When a difference is greater than or equal to the set angle threshold, it is determined that the pixel belongs to a vertex of a polygonal contour of a building. When the difference is less than the set angle threshold, it is determined that the pixel does not belong to the vertex of the polygonal contour of the building. For example, for the pixel p₂, it may be judged whether the difference between the target angle of the pixel p₂ and the target angle of the adjacent pixel p₁ is greater than or equal to the set angle threshold. The angle threshold may be set according to actual situations.

When the direction angle information is a direction type, it may be judged whether a difference between the direction type of the pixel and the direction type of an adjacent pixel is greater than or equal to a set direction type threshold. When a difference is greater than or equal to the set direction type threshold, it is determined that the pixel belongs to a vertex of a polygonal contour of a building. When the difference is less than the set direction type threshold, it is determined that the pixel does not belong to the vertex of the polygonal contour of the building. That is, it may be determined whether each pixel of the plurality of pixels belongs to the vertex of the polygonal contour of the building by using the following formula (2):

$${y}_{v e r t e x} ( {p}_{i} ) = \{ \begin{matrix}1 , {y}_{orient} ( {p}_{i} ) - {y}_{orient} ( {p}_{i - 1} ) \geq {t}_{orient} \\ 0 , {y}_{orient} ( {p}_{i} ) - {y}_{orient} ( {p}_{i - 1} ) < {t}_{orient}\end{matrix} \qquad Formula ( 2 )$$

yᵥₑᵣₜₑₓ(pᵢ)=1 indicates that a pixel pᵢ belongs to a vertex of a polygonal contour of a building. yᵥₑᵣₜₑₓ(pᵢ)=0 indicates that the pixel pᵢ does not belong to the vertex of the polygonal contour of the building. yₒᵣᵢₑₙₜ(pᵢ) is a direction type of the pixel pᵢ·yₒᵣᵢₑₙₜ(Pᵢ₋₁) is a direction type of a pixel pᵢ₋₁·tₒᵣᵢₑₙₜ is a set direction type threshold, and the value of tₒᵣᵢₑₙₜ may be set according to actual situations.

S603 is described, and then a vertex position set corresponding to the building may be determined according to the determined positions of respective pixels belonging to the vertex. Exemplarily, the vertex position set corresponding to each building may be determined by a vertex selection module. For example, a local binary image corresponding to a building and direction angle information of a contour pixel located on the building contour in the local binary image may be input to the vertex selection module to determine a vertex position set corresponding to the building.

For S502, after the vertex position set corresponding to each building is obtained, a labeled image labeled with the polygonal contour of the at least one building in the remote sensing image may be generated based on the vertex position sets respectively corresponding to the buildings. For example, a connection order of vertices included in each building may be determined, and the vertices corresponding to each building are connected without crossing according to the determined connection order to obtain a polygonal contour of each building. A labeled image corresponding to the remote sensing image is generated based on the polygonal contour of each building and the remote sensing image.

In an optional implementation, before the labeled image labeled with the polygonal contour of the at least one building in the remote sensing image is generated based on the vertex position sets respectively corresponding to the buildings, the method may further includes the following operation. A position of each of vertices in the determined vertex position set is corrected based on a trained vertex correction neural network.

Here, the vertex position set may be input to a trained vertex correction neural network, and the position of each of vertices in the determined vertex position set is corrected to obtain a corrected vertex position set. Further, a labeled image labeled with a polygonal contour of at least one building in the remote sensing image may be generated based on the corrected vertex position set respectively corresponding to each building.

In the above implementation, the position of each vertex in the vertex position set may also be corrected through a trained vertex correction neural network, so that the corrected position of each vertex is more consistent with a real position, and then a labeled image with high accuracy may be obtained based on the corrected vertex position set corresponding to each building respectively.

In an optional implementation, after the labeled image labeled with the polygonal contour of the at least one building in the remote sensing image is generated based on the vertex position sets respectively corresponding to the buildings, the method may further include the following operation. The position of any vertex is adjusted in response to a vertex position adjustment operation performed on the labeled image.

Here, after a labeled image is obtained, the labeled image may be displayed on a display screen. For example, when the executive subject is a terminal device having a display screen, the labeled image may be displayed on the display screen of the terminal device, or, when the executive subject is a server, the labeled image may also be sent to the display device, so that the labeled image may be displayed on the display screen of the display device, and a labeling operator may view the labeled image displayed on the display screen. When the position of any vertex of any building in the labeled image does not match the actual situation, the position of the vertex may be adjusted, and in response to a vertex position adjustment operation performed on the labeled image, the position of any vertex may be adjusted to obtain a labeled image with an adjusted vertex position. The vertex position adjustment operation performed on the labeled image may be performed in real time after the labeled image is generated, or may be performed in non-real time after the labeled image is generated.

Here, it is also possible to perform an adjustment operation on the position of any vertex on a labeled image, thereby improving the accuracy of the labeled image after the vertex position is adjusted.

Exemplarily, after a remote sensing image is acquired, the remote sensing image may be input into a labeling network to generate a labeled image corresponding to the remote sensing image. The labeled image is labeled with a polygonal contour of at least one building in the remote sensing image. The labeling network may include a first image segmentation neural network, a second image segmentation neural network, a vertex selection module, and a vertex correction neural network. The working process of the labeling network may be described with reference to the above description and will not be elaborated herein.

It will be appreciated by those skilled in the art that the order in which the steps are written in the above method of the specific implementation does not imply a strict order of execution but constitutes any limitation on the implementation process, and that the order in which the steps are performed should be determined in terms of their functionality and possible inherent logic.

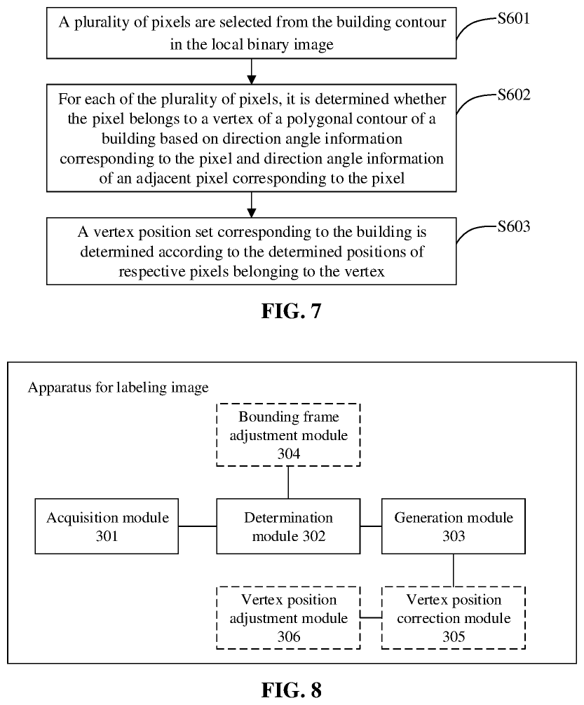

Based on the same concept, an embodiment of the disclosure also provides an apparatus for labeling an image. FIG. 8 shows a schematic architecture diagram of an apparatus for labeling an image according to an embodiment of the disclosure. The apparatus includes an acquisition module 301, a determination module 302, a generation module 303, a bounding frame adjustment module 304, a vertex position correction module 305, and a vertex position adjustment module 306.

The acquisition module 301 is configured to acquire a remote sensing image.

The determination module 302 is configured to determine a local binary image respectively corresponding to at least one building in the remote sensing image and direction angle information of a contour pixel located on a building contour in the local binary image based on the remote sensing image. The direction angle information includes information of an angle between a contour edge where the contour pixel is located and a preset reference direction.

The generation module 303 is configured to generate a labeled image labeled with a polygonal contour of the at least one building in the remote sensing image based on the local binary image respectively corresponding to the at least one building and the direction angle information.

In a possible implementation, when the local binary image respectively corresponding to the at least one building in the remote sensing image and the direction angle information of the contour pixel located on the building contour in the local binary image are determined based on the remote sensing image, the determination module 302 is configured to perform the following operations.

A global binary image of the remote sensing image, direction angle information of a contour pixel located on a building contour in the global binary image, and bounding frame information of a bounding frame of at least one building are acquired based on the remote sensing image and a trained first image segmentation neural network.

The local binary image respectively corresponding to the at least one building in the remote sensing image and the direction angle information of the contour pixel located on the building contour in the local binary image are determined based on the bounding frame information, the global binary image, the direction angle information of the contour pixel located on the building contour in the global binary image, and the remote sensing image.

In a possible implementation, the determination module 302 is configured to determine the local binary image respectively corresponding to the at least one building in the remote sensing image and the direction angle information of the contour pixel located on the building contour in the local binary image according to the following implementations.

A first bounding frame having a size greater than a preset size threshold is selected from the at least one bounding frame based on the bounding frame information.

A local binary image of a building within the first bounding frame is clipped from the global binary image based on the bounding frame information of the first bounding frame, and direction angle information of a contour pixel located on the building contour in the clipped local binary image is extracted from the direction angle information corresponding to the global binary image.

In a possible implementation, the determination module 302 is further configured to determine the local binary image respectively corresponding to the at least one building in the remote sensing image and the direction angle information of the contour pixel located on the building contour in the local binary image according to the following implementations.

A second bounding frame having a size less than or equal to the preset size threshold is selected from the at least one bounding frame based on the bounding frame information.

A local remote sensing image corresponding to the second bounding frame is clipped from the remote sensing image based on bounding frame information of the second bounding frame.

A local binary image of the building corresponding to the local remote sensing image, and direction angle information of a contour pixel located on the building contour in a local binary image corresponding to the local remote sensing image are determined based on the local remote sensing image and a trained second image segmentation neural network.

In a possible implementation, after the bounding frame information of the at least one bounding frame is acquired, the apparatus may further include the bounding frame adjustment module 304.

The bounding frame adjustment module 304 is configured to generate a first labeled remote sensing image labeled with the at least one bounding frame based on the remote sensing image and the bounding frame information of the at least one bounding frame, and obtain bounding frame information of an adjusted bounding frame in response to a bounding frame adjustment operation performed on the first labeled remote sensing image.

In a possible implementation, the determination module 302 is configured to train the first image segmentation neural network by the following steps.

A first remote sensing image sample carrying a first labeling result is acquired. The first remote sensing image sample includes an image of at least one building. The first labeling result includes labeled contour information of the at least one building, a binary image of the first remote sensing image sample, and direction angle information corresponding to each of pixels in the first remote sensing image sample.

The first remote sensing image sample is input into a first neural network to be trained to obtain a first prediction result corresponding to the first remote sensing image sample, the first neural network to be trained is trained based on the first prediction result and the first labeling result, and the first image segmentation neural network is obtained after the training is completed.

In a possible implementation, the determination module 302 is configured to train the second image segmentation neural network by the following steps.

Second remote sensing image samples carrying a second labeling result are acquired. Each of the second remote sensing image samples is a region image of a target building clipped from the first remote sensing image sample. The second labeling result includes contour information of the target building in the region image, a binary image of the second remote sensing image sample, and direction angle information corresponding to each of pixels in the second remote sensing image sample.

The second remote sensing image sample is input into a second neural network to be trained to obtain a second prediction result corresponding to the second remote sensing image sample, the second neural network to be trained is trained based on the second prediction result and the second labeling result, and the second image segmentation neural network is obtained after the training is completed.

In a possible implementation, in the process that the labeled image labeled with the polygonal contour of the at least one building in the remote sensing image is generated based on the local binary image respectively corresponding to the at least one building and the direction angle information, the generation module 303 is configured to perform the following operations.

For each building, a vertex position set corresponding to the building is determined based on the local binary image corresponding to the building and direction angle information of a contour pixel located on the building contour in the local binary image. The vertex position set includes positions of a plurality of vertices of a polygonal contour of the building.

A labeled image labeled with the polygonal contour of the at least one building in the remote sensing image is generated based on the vertex position sets respectively corresponding to the buildings.

In a possible implementation, before the labeled image labeled with the polygonal contour of the at least one building in the remote sensing image is generated based on the vertex position sets respectively corresponding to the buildings, the apparatus may further include the vertex position correction module 305.

The vertex position correction module 305 is configured to correct a position of each of vertices in the determined vertex position set based on a trained vertex correction neural network.

In a possible implementation, after the labeled image labeled with the polygonal contour of the at least one building in the remote sensing image is generated based on the vertex position sets respectively corresponding to the buildings, the apparatus may further include the vertex position adjustment module 306.

The vertex position adjustment module 306 is configured to adjust the position of any vertex in response to a vertex position adjustment operation performed on the labeled image.

In a possible implementation, in the process that the vertex position set corresponding to the building is determined based on the local binary image corresponding to the building and the direction angle information of the contour pixel located on the building contour in the local binary image, the generation module 303 is configured to perform the following operations.

A plurality of pixels are selected from the building contour in the local binary image.

For each of the plurality of pixels, it is determined whether the pixel belongs to a vertex of a polygonal contour of a building based on direction angle information corresponding to the pixel and direction angle information of an adjacent pixel corresponding to the pixel.

A vertex position set corresponding to the building is determined according to the positions of respective pixels belonging to the vertex.

In a possible implementation, in the process that it is determined whether the pixel belongs to the vertex of the polygonal contour of the building based on the direction angle information corresponding to the pixel and the direction angle information of the adjacent pixel corresponding to the pixel, the generation module 303 is configured to perform the following operations.

It is determined that the pixel belongs to the vertex of the polygonal contour of the building when a difference between the direction angle information of the pixel and the direction angle information of the adjacent pixel satisfies a set condition.

In a possible implementation, when the labeled direction angle information corresponding to each pixel is direction type information, the determination module 302 is configured to acquire the direction type information corresponding to each pixel according to the following steps.

A target angle between a contour edge where the pixel is located and a set reference direction is determined.

Direction type information corresponding to the pixel is determined according to a corresponding relationship between different direction type information and an angle range, and the target angle.

In some embodiments, functions or templates of the apparatus provided by the embodiment of the disclosure may be configured to perform the method as described above with respect to the method embodiment, and the implementation thereof may be described with reference to the description of the method embodiment and, for brevity, will not be elaborated herein.

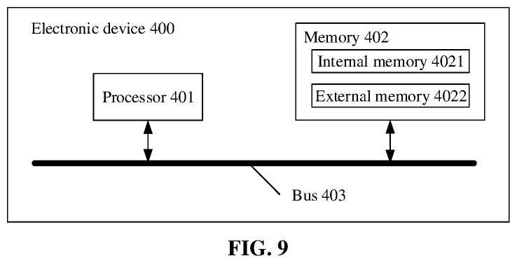

Based on the same technical concept, an embodiment of the disclosure also provides an electronic device. FIG. 9 shows a schematic structural diagram of an electronic device according to an embodiment of the disclosure. The electronic device includes a processor 401, a memory 402, and a bus 403. The memory 402 is configured to store execution instructions, and includes an internal memory 4021 and an external memory 4022. The internal memory 4021 here is also referred to as an internal storage, and is configured to temporarily store operation data in the processor 401 and data exchanged with the external memory 4022 such as a hard disk. The processor 401 exchanges data with the external memory 4022 through the internal memory 4021. During the operation of the electronic device 400, the processor 401 communicates with the memory 402 through the bus 403, so that the processor 401 executes the following instructions.

A remote sensing image is acquired.

A local binary image respectively corresponding to at least one building in the remote sensing image and direction angle information of a contour pixel located on a building contour in the local binary image are determined based on the remote sensing image. The direction angle information includes information of an angle between a contour edge where the contour pixel is located and a preset reference direction.

A labeled image labeled with a polygonal contour of the at least one building in the remote sensing image is generated based on the local binary image respectively corresponding to the at least one building and the direction angle information.

In addition, an embodiment of the disclosure also provides a computer-readable storage medium, which has a computer program stored thereon which, when executed by a processor, performs the steps of the method for labeling an image in the above method embodiment.

A computer program product for a method for labeling an image provided by an embodiment of the disclosure includes a computer-readable storage medium storing a program code including instructions operable to perform the steps of the method for labeling an image in the above method embodiment. The computer program product may be referred to the above method embodiment and will not be elaborated herein.

An embodiment of the disclosure also provide a computer program that, when executed by a processor, performs any of the methods of the preceding embodiments. The computer program product may be implemented in hardware, software, or a combination thereof. In an optional embodiment, the computer program product is embodied as a computer storage medium. In another optional embodiment, the computer program product is embodied as a software product, for example, a Software Development Kit (SDK).

Those skilled in the art may clearly learn about that working processes of the system and apparatus described above may refer to the corresponding processes in the method embodiment and will not be elaborated herein for convenient and brief description. In some embodiments provided by the disclosure, it is to be understood that the disclosed system, apparatus, and method may be implemented in another manner The apparatus embodiment described above is only schematic. For example, division of the units is only logic function division, and other division manners may be adopted during practical implementation. For another example, multiple units or components may be combined or integrated into another system, or some characteristics may be neglected or not executed. In addition, coupling or direct coupling or communication connection between each displayed or discussed component may be indirect coupling or communication connection, implemented through some communication interfaces, of the apparatus or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit.

When realized in form of a software function unit and sold or used as an independent product, the function may also be stored in a non-volatile computer-readable storage medium executable for the processor. Based on such an understanding, the technical solutions of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device, etc.) to execute all or part of the steps of the method in each embodiment of the disclosure. The foregoing storage medium includes various media capable of storing program codes such as a U disk, a mobile hard disk, a Read-Only Memory (ROM), a Random Access Memory (RAM), a magnetic disk, or an optical disk.

The above is only the specific implementation of the disclosure and not intended to limit the scope of protection of the disclosure. Any variations or replacements apparent to those skilled in the art within the technical scope disclosed by the disclosure should fall within the scope of protection of the disclosure. Therefore, the scope of protection of the disclosure should be determined by the scope of protection of the claims.

### INDUSTRIAL APPLICABILITY

According to the embodiments of the disclosure, a local binary image respectively corresponding to at least one building in a remote sensing image and direction angle information of a contour pixel located on a building contour in the local binary image are determined based on the remote sensing image. The direction angle information includes information of an angle between a contour edge where the contour pixel is located and a preset reference direction. A labeled image labeled with a polygonal contour of the at least one building in the remote sensing image is generated based on the local binary image respectively corresponding to the at least one building and the direction angle information. The automatic generation of the labeled image labeled with the polygonal contour of the at least one building in the remote sensing image is realized, and the efficiency of building labeling is improved. Meanwhile, since a pixel located at a vertex position on an edge contour of a building and an adjacent pixel are located on different contour edges and different contour edges correspond to different directions, the vertex position of the building may be determined more accurately through a local binary image corresponding to the building and direction angle information, and then a labeled image may be generated more accurately.

1. A method for labeling an image, comprising:
acquiring a remote sensing image;
determining a local binary image respectively corresponding to at least one building in the remote sensing image and direction angle information of a contour pixel located on a building contour in the local binary image based on the remote sensing image, the direction angle information comprising information of an angle between a contour edge where the contour pixel is located and a preset reference direction; and
generating a labeled image labeled with a polygonal contour of the at least one building in the remote sensing image based on the local binary image respectively corresponding to the at least one building and the direction angle information.

2. The method of claim 1, wherein determining the local binary image respectively corresponding to the at least one building in the remote sensing image and the direction angle information of the contour pixel located on the building contour in the local binary image based on the remote sensing image comprises:
acquiring a global binary image of the remote sensing image, direction angle information of a contour pixel located on a building contour in the global binary image, and bounding frame information of a bounding frame of at least one building based on the remote sensing image and a trained first image segmentation neural network; and
determining the local binary image respectively corresponding to the at least one building in the remote sensing image and the direction angle information of the contour pixel located on the building contour in the local binary image based on the bounding frame information, the global binary image, the direction angle information of the contour pixel located on the building contour in the global binary image, and the remote sensing image.

3. The method of claim 2, wherein determining the local binary image respectively corresponding to the at least one building in the remote sensing image and the direction angle information of the contour pixel located on the building contour in the local binary image comprises:
selecting a first bounding frame having a size greater than a preset size threshold from the at least one bounding frame based on the bounding frame information; and
intercepting a local binary image of a building within the first bounding frame from the global binary image based on the bounding frame information of the first bounding frame, and extracting direction angle information of a contour pixel located on the building contour in the clipped local binary image from the direction angle information corresponding to the global binary image.

4. The method of claim 2, wherein determining the local binary image respectively corresponding to the at least one building in the remote sensing image and the direction angle information of the contour pixel located on the building contour in the local binary image comprises:
selecting a second bounding frame having a size less than or equal to a preset size threshold from the at least one bounding frame based on the bounding frame information;
intercepting a local remote sensing image corresponding to the second bounding frame from the remote sensing image based on bounding frame information of the second bounding frame; and
determining a local binary image of the building corresponding to the local remote sensing image, and direction angle information of a contour pixel located on the building contour in a local binary image corresponding to the local remote sensing image based on the local remote sensing image and a trained second image segmentation neural network.

5. The method of claim 2, wherein after acquiring the bounding frame information of the at least one bounding frame, the method further comprises:
generating a first labeled remote sensing image labeled with the at least one bounding frame based on the remote sensing image and the bounding frame information of the at least one bounding frame; and
obtaining bounding frame information of an adjusted bounding frame in response to a bounding frame adjustment operation performed on the first labeled remote sensing image.

6. The method of claim 2, further comprising:
acquiring a first remote sensing image sample carrying a first labeling result, the first remote sensing image sample comprising an image of at least one building, and the first labeling result comprising labeled contour information of the at least one building, a binary image of the first remote sensing image sample, and labeled direction angle information corresponding to each of pixels in the first remote sensing image sample; and
inputting the first remote sensing image sample into a first neural network to be trained to obtain a first prediction result corresponding to the first remote sensing image sample, training the first neural network to be trained based on the first prediction result and the first labeling result, and obtaining the first image segmentation neural network after the training is completed.

7. The method of claim 4, further comprising:
acquiring second remote sensing image samples carrying a second labeling result, each of the second remote sensing image samples being a region image of a target building clipped from a first remote sensing image sample, and the second labeling result comprising contour information of the target building in the region image, a binary image of the second remote sensing image sample, and labeled direction angle information corresponding to each of pixels in the second remote sensing image sample; and
inputting the second remote sensing image samples into a second neural network to be trained to obtain a second prediction result corresponding to the second remote sensing image samples, training the second neural network to be trained based on the second prediction result and the second labeling result, and obtaining the second image segmentation neural network after the training is completed.

8. The method of claim 1, wherein generating the labeled image labeled with the polygonal contour of the at least one building in the remote sensing image based on the local binary image respectively corresponding to the at least one building and the direction angle information comprises:
determining, for each building, a vertex position set corresponding to the building based on the local binary image corresponding to the building and direction angle information of a contour pixel located on the building contour in the local binary image, the vertex position set comprising positions of a plurality of vertices of a polygonal contour of the building; and
generating a labeled image labeled with the polygonal contour of the at least one building in the remote sensing image based on the vertex position sets respectively corresponding to the buildings.

9. The method of claim 8, wherein before generating the labeled image labeled with the polygonal contour of the at least one building in the remote sensing image based on the vertex position sets respectively corresponding to the buildings, the method further comprises:
correcting a position of each of vertices in the determined vertex position set based on a trained vertex correction neural network.

10. The method of claim 8, wherein after generating the labeled image labeled with the polygonal contour of the at least one building in the remote sensing image based on the vertex position sets respectively corresponding to the buildings, the method further comprises:
adjusting a position of any vertex in response to a vertex position adjustment operation performed on the labeled image.

11. The method of claim 8, wherein determining the vertex position set corresponding to the building based on the local binary image corresponding to the building and the direction angle information of the contour pixel located on the building contour in the local binary image comprises:
selecting a plurality of pixels from the building contour in the local binary image;
determining, for each of the plurality of pixels, whether the pixel belongs to a vertex of a polygonal contour of a building based on direction angle information corresponding to the pixel and direction angle information of an adjacent pixel corresponding to the pixel; and
determining a vertex position set corresponding to the building according to the positions of respective pixels belonging to the vertex.

12. The method of claim 11, wherein determining whether the pixel belongs to the vertex of the polygonal contour of the building based on the direction angle information corresponding to the pixel and the direction angle information of the adjacent pixel corresponding to the pixel comprises:
determining that the pixel belongs to the vertex of the polygonal contour of the building when a difference between the direction angle information of the pixel and the direction angle information of the adjacent pixel satisfies a set condition.

13. The method of claim 6, wherein the labeled direction angle information corresponding to each pixel comprises labeling direction type information, the method further comprises:
determining a target angle between a contour edge where the pixel is located and a set reference direction; and
determining labeling direction type information corresponding to the pixel according to correspondences between different preset direction type information and angle ranges, and the target angle.

14. An electronic device, comprising a processor, a memory, and a bus, wherein the memory stores machine-readable instructions executable by the processor, when the electronic device operates, the processor communicates with the memory through the bus, and the machine-readable instructions are executed by the processor to perform steps of:
acquiring a remote sensing image;
determining a local binary image respectively corresponding to at least one building in the remote sensing image and direction angle information of a contour pixel located on a building contour in the local binary image based on the remote sensing image, the direction angle information comprising information of an angle between a contour edge where the contour pixel is located and a preset reference direction; and
generating a labeled image labeled with a polygonal contour of the at least one building in the remote sensing image based on the local binary image respectively corresponding to the at least one building and the direction angle information.

15. The electronic device of claim 14, wherein determining the local binary image respectively corresponding to the at least one building in the remote sensing image and the direction angle information of the contour pixel located on the building contour in the local binary image based on the remote sensing image comprises:
acquiring a global binary image of the remote sensing image, direction angle information of a contour pixel located on a building contour in the global binary image, and bounding frame information of a bounding frame of at least one building based on the remote sensing image and a trained first image segmentation neural network; and
determining the local binary image respectively corresponding to the at least one building in the remote sensing image and the direction angle information of the contour pixel located on the building contour in the local binary image based on the bounding frame information, the global binary image, the direction angle information of the contour pixel located on the building contour in the global binary image, and the remote sensing image.

16. The electronic device of claim 15, wherein determining the local binary image respectively corresponding to the at least one building in the remote sensing image and the direction angle information of the contour pixel located on the building contour in the local binary image comprises:
selecting a first bounding frame having a size greater than a preset size threshold from the at least one bounding frame based on the bounding frame information; and
intercepting a local binary image of a building within the first bounding frame from the global binary image based on the bounding frame information of the first bounding frame, and extracting direction angle information of a contour pixel located on the building contour in the clipped local binary image from the direction angle information corresponding to the global binary image.

17. The electronic device of claim 15, wherein determining the local binary image respectively corresponding to the at least one building in the remote sensing image and the direction angle information of the contour pixel located on the building contour in the local binary image comprises:
selecting a second bounding frame having a size less than or equal to a preset size threshold from the at least one bounding frame based on the bounding frame information;
intercepting a local remote sensing image corresponding to the second bounding frame from the remote sensing image based on bounding frame information of the second bounding frame; and
determining a local binary image of the building corresponding to the local remote sensing image, and direction angle information of a contour pixel located on the building contour in a local binary image corresponding to the local remote sensing image based on the local remote sensing image and a trained second image segmentation neural network.

18. The electronic device of claim 15, wherein after acquiring the bounding frame information of the at least one bounding frame, further comprising:
generating a first labeled remote sensing image labeled with the at least one bounding frame based on the remote sensing image and the bounding frame information of the at least one bounding frame; and
obtaining bounding frame information of an adjusted bounding frame in response to a bounding frame adjustment operation performed on the first labeled remote sensing image.

19. The electronic device of claim 15, further comprising:
acquiring a first remote sensing image sample carrying a first labeling result, the first remote sensing image sample comprising an image of at least one building, and the first labeling result comprising labeled contour information of the at least one building, a binary image of the first remote sensing image sample, and labeled direction angle information corresponding to each of pixels in the first remote sensing image sample; and
inputting the first remote sensing image sample into a first neural network to be trained to obtain a first prediction result corresponding to the first remote sensing image sample, training the first neural network to be trained based on the first prediction result and the first labeling result, and obtaining the first image segmentation neural network after the training is completed.

20. A computer-readable storage medium having stored thereon a computer program that when executed by a processor, performs steps of:
acquiring a remote sensing image;
determining a local binary image respectively corresponding to at least one building in the remote sensing image and direction angle information of a contour pixel located on a building contour in the local binary image based on the remote sensing image, the direction angle information comprising information of an angle between a contour edge where the contour pixel is located and a preset reference direction; and
generating a labeled image labeled with a polygonal contour of the at least one building in the remote sensing image based on the local binary image respectively corresponding to the at least one building and the direction angle information.
